(19) United States
(12) Patent Application Publication
(10) Pub. No.: US 2010/0017276 A1
(43) Pub. Date: Jan. 21, 2010

(54) SYSTEM AND COMPUTER PROGRAM FOR MANAGING AND TRACKING RECYCLABLE PRODUCTS

(75) Inventors: Paul Kenneth Wolff, Calabasas, CA (US); Anthony Joaquin Zolezzi, Los Angeles, CA (US)

Correspondence Address: GARDERE WYNNE SEWELL LLP;INTELLECTUAL PROPERTY SECTION, 3000 THANKSGIVING TOWER, 1601 ELM ST, DALLAS, TX, 75201-4761, US

(73) Assignee: WM GreenOps. LLC, Houston, TX (US)

(21) Appl. No.: 12/492,291

(22) Filed: Jun. 26, 2009

Related U.S. Application Data
(60) Provisional application No. 61/082,095, filed on Jul. 18, 2008.

(51) Int. Cl. G06Q 30/00

(52) U.S. Cl. 705/14.1; 235/385

(57) ABSTRACT

A system, computer program product for managing and tracking recyclable products. The computer program product includes computer codes for uniquely associating one or more recyclable products with unique identifiers and other product information stored in a database, receiving tracking information associated with the one or more recyclable products, periodically storing and updating the tracking information in the database, associating the unique identifier with a recycling user having user account information stored in the database, updating the reward total based on a recycling activity of the recycling user, and updating the reward total based on a recycling activity of the recycling user. Each recyclable product includes indicia that is both a unique scannable identifier and a visual indicator that the recyclable product is recyclable. The visual indicator is arranged to encourage recycling. The tracking information includes information scanned at one or more stages of the lifecycle of the one or more recyclable products. The user account information includes user information including a reward total and recycling data associated with the recycling user.

### CROSS REFERENCE TO RELATED APPLICATIONS

The present application claims the benefit of the earlier filing date of U.S. provisional patent application Ser. No. 61/082,095, entitled “Bluedot—Method for the Design, Fabrication, Tracking and Recycling of Consumer Packaging and Products,” filed in the U.S. Patent and Trademark Office on Jul. 18, 2008, having common inventors as the present document and hereby incorporated by reference.

### BACKGROUND OF THE INVENTION

1. Field of the Invention

The present invention is generally related to managing and tracking recyclable materials at the product level, and more particularly to a system and computer program for managing and tracking recyclable products.

2. Discussion of the Background

Many products are recyclable, including electronic and medical products, plastic bottles, glass, paper, metal containers and other recyclable packaging, containers and products. Such products are known as recyclable products. Similar to other products, recyclable products are manufactured, distributed and sold to consumers, typically at retail locations. After consumption, the consumer may return the recyclable product to a recycling center, segregate the recycling product in a recycle bin during trash pickup, or otherwise dispose of the recyclable product in a way that the recyclable product may be recycled. The recyclable product is then recycled and reprocessed. Until recently, the handling of recyclable products returned to a recycling center or otherwise received has been completely manual. Even today, the handling of such recyclable products remains manually intensive.

There are numerous deficiencies associated with recycling in general, and, in particular, with managing and tracking recyclable products, including without limitation an efficient way to capture, audit and authenticate unique recyclable products, maintain and manage attributes and other information relating to recyclable products, track the location of recyclable products during their lifecycle, and reduce the manual labor associated with recycling.

Many recyclable products are never recycled and end up in landfills and/or are incinerated which unnecessarily increases waste and pollution. One non-limiting type recycling product that is particularly problematic is plastic recyclable products. Today, very little plastic recyclable products are recycled and reprocessed. Such plastic recyclable products make up a tremendous volume in landfills and clog pipes and waterways throughout the world. For instance, the disposal of plastic recyclable products has created plastic vortexes or islands the size of the continental United States in the Pacific ocean that will be around for thousands of years. Unfortunately, an efficient way of encouraging consumers to recycle along with managing and tracking such recyclable products does not exist in the prior art. Until the deficiencies associated with recycling are resolved, such examples of waste and pollution will continue.

Thus, there currently exists deficiencies associated with recycling in general, and, in particular, with managing and tracking recyclable products.

### SUMMARY OF THE INVENTION

Accordingly, one aspect of the present invention is to provide a computer program product embodied on a computer readable medium for managing and tracking recyclable products. The computer program product includes a first computer code for uniquely associating one or more recyclable products with unique identifiers and other product information stored in a database, a second computer code for receiving tracking information associated with the one or more recyclable products, wherein the tracking information includes information scanned at one or more stages of the lifecycle of the one or more recyclable products, a third computer code for periodically storing and updating the tracking information in the database, a fourth computer code for associating the unique identifier with a recycling user having user account information stored in the database, a fifth computer code for updating a reward total based on a recycling activity of the recycling user, and a sixth computer code for communicating the product information, tracking information, and account information to the recycling user over a network. Each recyclable product includes indicia that is both a unique scannable identifier and a visual indicator that the recyclable product is recyclable. The visual indicator is arranged to encourage recycling. The user account information includes user information including the reward total and recycling data associated with the recycling user.

Another aspect of the present invention is to provide a system for managing and tracking recyclable products. The system includes a plurality of remote computers of recycling users, a central server, a network interface in communication with the central server and the plurality of remote computers over a network, and a database in communication with the central server. The central server is configured to uniquely associate one or more recyclable products with unique identifiers and other product information stored in the database, receive tracking information associated with the one or more recyclable products, periodically store and update the tracking information in the database, associate the unique identifier with a recycling user having user account information stored in the database, update a reward total based on a recycling activity of the recycling user, and communicate the product information, tracking information, and account information to the recycling user via a first computer of the plurality of remote computers over the network interface. Each recyclable product includes indicia that is both a unique scannable identifier and a visual indicator that the recyclable product is recyclable. The visual indicator is arranged to encourage recycling. The network interface is configured to receive tracking information associated with one or more recyclable products. The tracking information includes information scanned at one or more stages of the lifecycle of the one or more recyclable products. The user account information includes user information including the reward total and recycling data associated with the recycling user.

### BRIEF DESCRIPTION OF THE DRAWINGS

A more complete appreciation of the present invention and many of the attendant advantages thereof will be readily obtained as the same becomes better understood by reference to the following detailed description when considered in conjunction with the accompanying drawings, wherein:

FIG. 1 is a block diagram illustrating an arrangement for managing and tracking recyclable products in accordance with an embodiment of the present invention;

FIG. 2 is a flow chart illustrating a method for managing and tracking recyclable products in accordance with an embodiment of the present invention;

FIG. 3A is a block diagram illustrating the placement of a unique identifier on a recyclable product in accordance with an embodiment of the present invention;

FIG. 3B is a block diagram illustrating an automated recyclable product collection location in accordance with an embodiment of the present invention;

FIG. 4 is a block diagram illustrating exemplary database tables used for managing and tracking recyclable products in accordance with an embodiment of the present invention; and

FIG. 5 is a block diagram illustrating the unique identifier used for managing and tracking recyclable products in accordance with an embodiment of the present invention.

### DETAILED DESCRIPTION THE PREFERRED EMBODIMENTS

Referring now to the drawings, wherein like reference numerals designate identical or corresponding parts throughout the several views, preferred embodiments of the present invention are described.

The present invention provides a computer program and method for managing and tracking recyclable products, including without limitation a way to easy capture, audit and authenticate unique recyclable products, maintain and manage attributes and other information relating to the recyclable products, and track the location of recyclable products during their lifecycle. The present invention also encourages consumers to recycle, improves automation and reduces manual labor associated with recycling. Thereby, the amount of material recycled and reprocessed is increased. The present invention provides for the easy capture and authentication of recyclable products, and provides recycling users the ability to audit the recyclable products and to confirm that the recyclable products were reprocessed, as opposed to buried in landfills and/or burned in incinerators in the United States or abroad.

The present invention provides recycling users with information associated with the recyclable products, including without limitations the ability to uniquely track recyclable products and ascertain other information about such recyclable products, such as its attributes and location. Using the present invention, a recycling user may confirm whether the recyclable product is composed of non-toxic or toxic materials, manage recycling product information, and track the recyclable product during its lifecycle in near real-time using an online web server.

In one embodiment, each recyclable product has a unique identifier and other indicia included in the printed label or product for capturing redundancies. The system uses proprietary algorithms to create unique unit level bar or symbol based security or tracking codes. Security or tracking codes are generated on demand when the recyclable product is manufactured or packaged. An open architecture which allows for flexible integration into various manufacturing environments is utilized. Security or tracking codes are encrypted with the strongest methodology available with non-sequential, non-predictable and non-repeating codes.

According to one embodiment, recyclable products can be verified at any point in the supply chain via without limitation the Internet, SMS, a hand-held scanner, or a camera phone. Security or tracking codes can be authenticated by manufacturers, security personnel, retail associates and consumers at various stages in the recyclable product's lifecycle. Unit level authentication is available to a user using a camera phone, a hand-held scanner, SMS, or by means of the Internet.

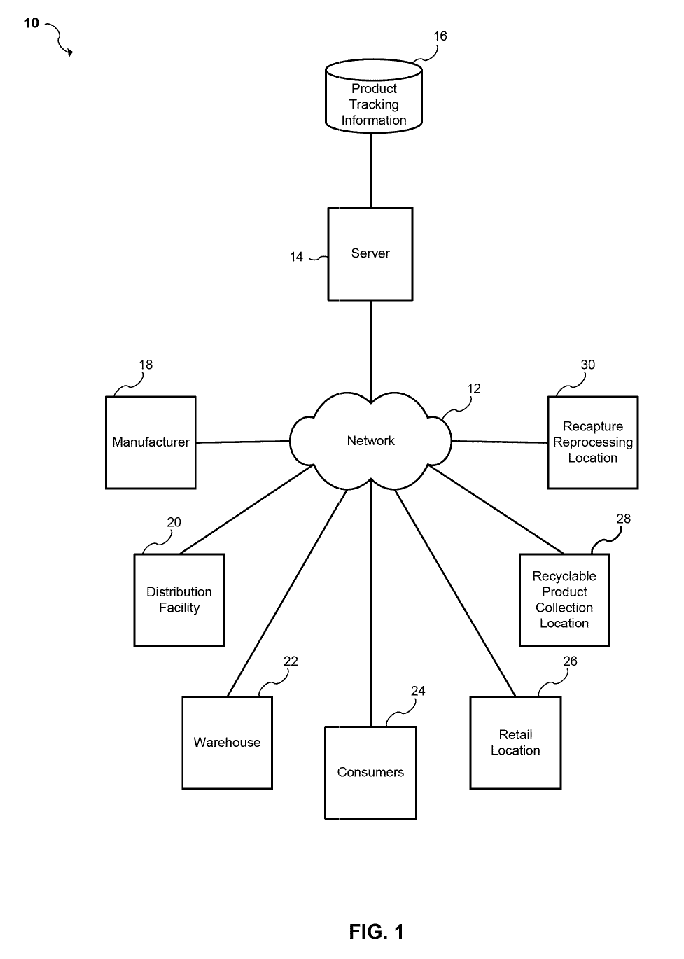

Referring to FIG. 1, a block diagram illustrating an arrangement for managing and tracking recyclable products in accordance with an embodiment of the present invention is shown. According to this arrangement, one or more users associated with a recyclable product's lifecycle communicate with server 14 to access and possibly update information associated with recyclable products. Users associated with a recyclable product's lifecycle or otherwise interested in recycling, referred to herein as recycling users, include without limitation manufacturers 18, distribution facilities 20, warehouses 22, retail locations 24, consumers 26, recyclable product collection locations 28 and recapture reprocessing locations 30. The recyclable product information is stored in one or more databases 16 in communication with server 14.

In one non-limiting embodiment, server 14 is a web server, or the like, able to communicate with one or more users associated with a recyclable product's lifecycle via network 12, such as without limitation the Internet, an Intranet or other communication network. Server 14 includes a computer with one or more processors and a computer readable storage medium, such as without limitation a computer hard-drive, removable drive or memory. A computer program having executable instructions may be stored on the computer readable storage medium.

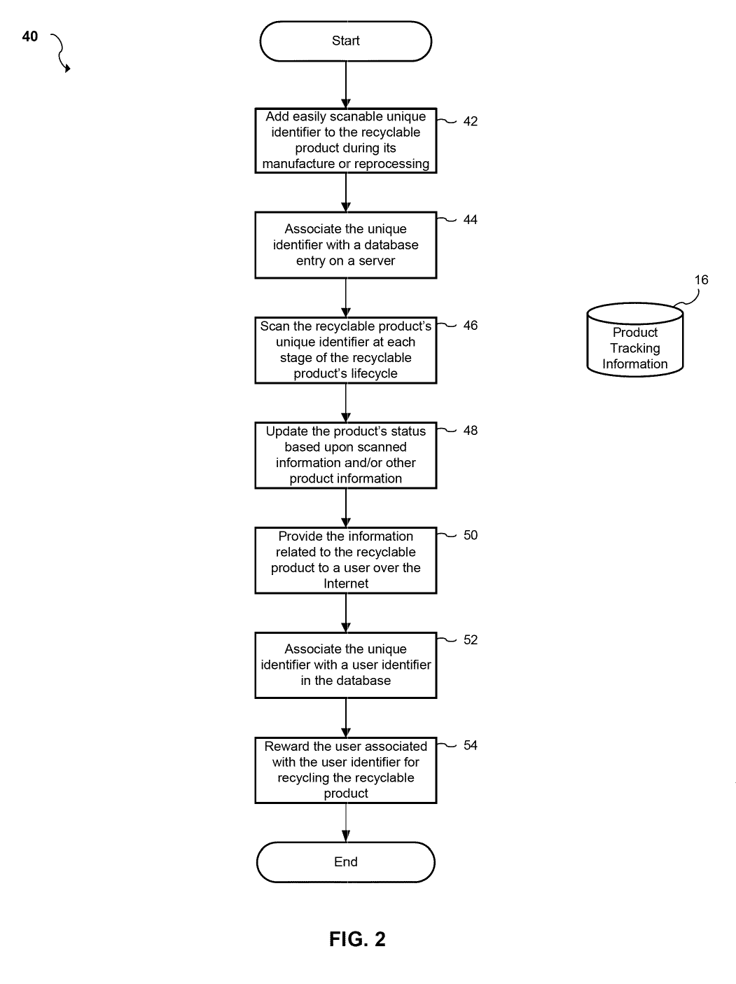

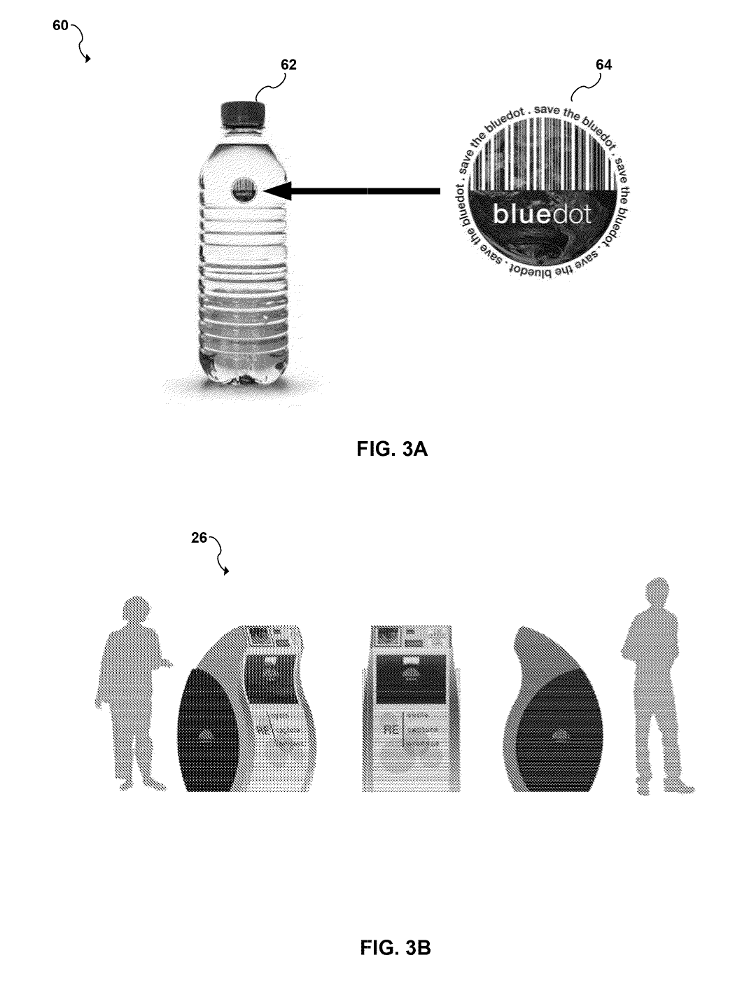

Referring to FIG. 2, a flow chart illustrating a method for managing and tracking recyclable products in accordance with an embodiment of the present invention is shown. At block 42, an scannable unique identifier is added to a recyclable product during its manufacture or reprocessing. The unique identifier visually identifies the product as a recyclable product to a consumer, thereby encouraging the consumer to recycle to the recyclable product each time the recyclable product is viewed or used by the recycling user. In one embodiment, a bluedot symbol 64 as shown in FIG. 3A is added to a recyclable product 62. The bluedot symbol 64 not only visually identifies the product as a recyclable product, but also uniquely identifies the recyclable product such that it may be tracked during its recyclable lifecycle. The unique identification may be by means of a unique bar code, tag, number, RFID or the like.

At block 44, the unique identifier is associated with at least one entry in a database, such as database 16 in communication with sever 14, as shown in FIG. 1. The recyclable product identifier may be scanned at one or more stages of the recyclable product's lifecycle, as shown at block 46. In one embodiment, the recyclable product identifier is scanned at each stage of the recyclable product's lifecycle. A recyclable product's lifecycle includes without limitation its manufacturing, storage, distribution, retail, recycling, and reprocessing stages. According to one embodiment, at one or more, or each, of these stages the unique identifier is scanned using a bar code reader. According to other embodiments, the identifier is scanned using other scanning technologies, such as without limitation laser, x-ray, UV florescent or RFID scanning. The recyclable product's status is updated based upon scanned information and/or other information manually or automatically entered at block 48.

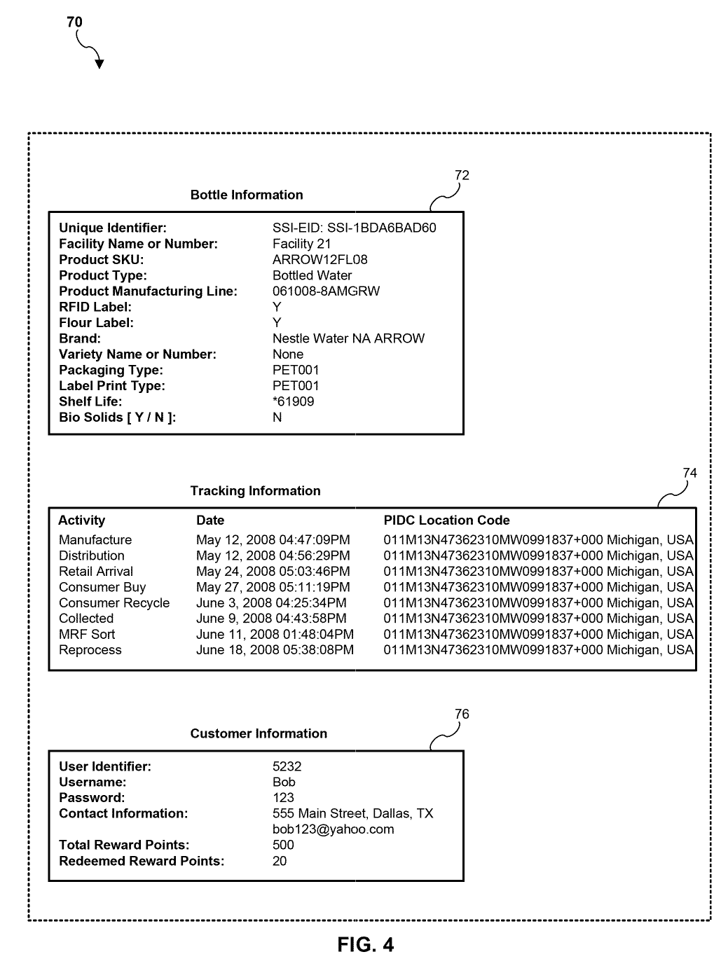

At block 50, information about the recyclable product is provided to a recycling user over a network, such as the Internet. In one embodiment, the information includes status information relating the stage of the recyclable product's lifecycle. As shown in table 74 of FIG. 4, the information may include tracking information, including without limitation the activity, date and PIDC location code. The PIDC location code is the product indentification code and may be used to indicate where and when an event occurred within the recyclable product's lifecycle. As shown in table 72 of FIG. 4, the information may also include bottle information, including without limitation a unique identifier, a facility name and/or number, a product SKU, a product type, a product manufacturing line, an indication of whether the recyclable product includes an RFID label, a brand, a variety name and/or number, a packaging type, a label print type, a shelf life, and an indication of whether the product is a plastic, glass aluminum, or other type of material. The type of material indicates whether the product is a bio solid or a technical solid. For instance, fruit waste is a bio solid and plastic is a technical solid.

At block 52, the unique identifier is associated with a user identifier in a database. In one embodiment, unique identifier is associated with a user identifier in a customer information table. As shown in table 76 of FIG. 4, customer information includes without limitation a user identifier, a username, a password, contact information, a total number of reward points and a redeemed number of reward points. Tie unique identifier may be associated with a user without limitation when it is purchased by a consumer and scanned at a retail location, when it is returned by the consumer after consumer to a recycling center, when it is picked up from a recycling container during trash pickup, or when the recyclable product is otherwise recycled by the consumer.

In one embodiment, the recyclable product is scanned by a recycling user at a recycling center, during trash pickup, at a reprocessing location, at home or at a community location. The scanned information is used to identifying the product as a recycle product and to automatically segregate the recyclable products into separate bins or storage locations. Thereby, the amount of manual labor required during recycling and reprocessing is reduced.

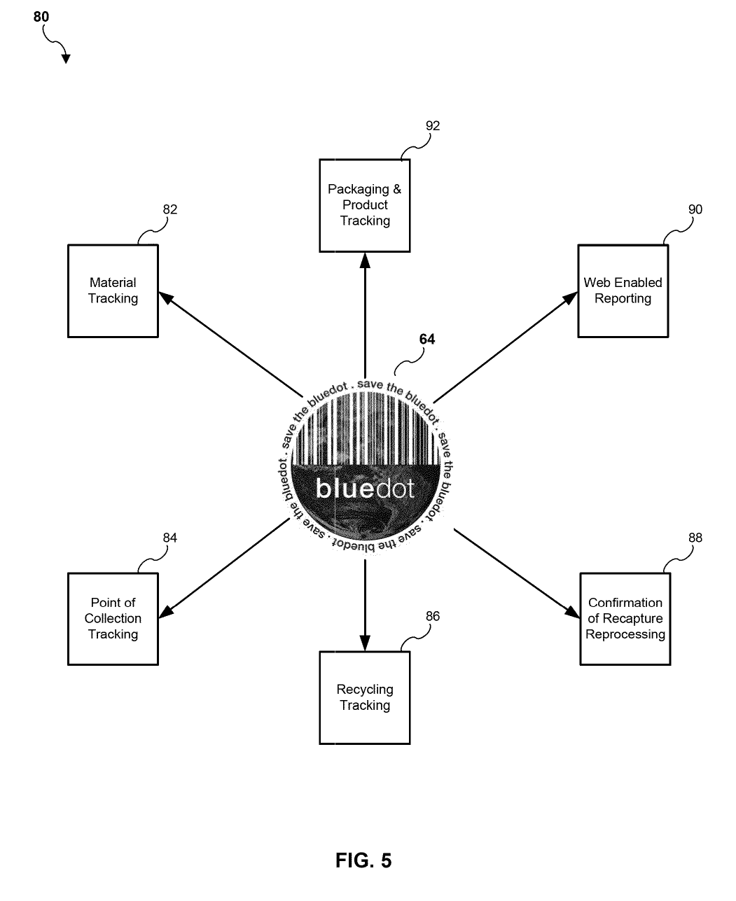

As shown in FIG. 5, according to one embodiment the unique identifier 64 may be used for material tracking 82, point of collection tracking 84, recycling tracking 86, confirmation of recapture reprocessing 88, web enabled reporting 90, and packing and product tracking 92.

The present invention thus includes a computer program which may be hosted on a storage medium and includes instructions which perform the processes set forth in the present specification. The storage medium can include, but is not limited to, any type of disk including floppy disks, optical disks, CD-ROMs, magneto-optical disks, ROMs, RAMs, EPROMs, EEPROMs, flash memory, magnetic or optical cards, or any type of media suitable for storing electronic instructions.

Obviously, many other modifications and variations of the present invention are possible in light of the above teachings. The specific embodiments discussed herein are merely illustrative, and are not meant to limit the scope of the present invention in any manner. It is therefore to be understood that within the scope of the disclosed concept, the invention may be practiced otherwise then as specifically described.

1. A computer program product embodied on a computer readable medium for managing and tracking recyclable products, the computer program product comprising:
a first computer code for uniquely associating one or more recyclable products with unique identifiers and other product information stored in a database, wherein each recyclable product includes indicia that is both a unique scannable identifier and a visual indicator that the recyclable product is recyclable, and the visual indicator is arranged to encourage recycling;
a second computer code for receiving tracking information associated with the one or more recyclable products, wherein the tracking information includes information scanned at one or more stages of the lifecycle of the one or more recyclable products;
a third computer code for periodically storing and updating the tracking information in the database;
a fourth computer code for associating the unique identifier with a recycling user having user account information stored in the database, wherein the user account information includes user information comprising a reward total and recycling data associated with the recycling user;
a fifth computer code for updating the reward total based on a recycling activity of the recycling user; and
a sixth computer code for communicating the product information, tracking information, and account information to the recycling user over a network.

2. The computer program product of claim 2, wherein the indicia is a unique bar code combined with a graphical symbol indicating to the recycling user that the one or more recyclable products are recyclable.

3. The computer program product of claim 2, further comprising a seventh computer code for scanning the bar code and communicating tracking information to the database via the network.

4. The computer program product of claim 2, wherein the indicia is an optically scannable unique identifier combined with a graphical symbol indicating to the recycling user that the one or more recyclable products are recyclable.

5. The computer program product of claim 4, wherein the optically scannable identifier is scanned using at least one of an x-ray, an opti-scanner, a material resonance scanner, and a UV scanner.

6. The computer program product of claim 2, wherein the indicia is an RFID combined with a graphical symbol indicating to the recycling user that the one or more recyclable products are recyclable.

7. The computer program product of claim 2, wherein the unique bar code is sequential and predictable.

8. The computer program product of claim 2, wherein the unique bar code is non-sequential and non-predictable.

9. The computer program product of claim 3, wherein at least one of the product information, tracking information, and account information is communicated to the recycling user over a network via at least one selected from the group consisting of SMS, an email and a communication protocol.

10. The computer program product of claim 2, further comprising a seventh computer code for verifying a status of one or more recyclable products using at least one selected from the group consisting of SMS, a hand-held scanner, and a camera phone.

11. The computer program product of claim 2, further comprising a seventh computer code for allowing the recycling user to confirm that the one or more recycling products has been reprocessed.

12. The computer program product of claim 2, further comprising a seventh computer code for allowing the recycling user to confirm that the one or more recycling products contains toxic materials.

13. The computer program product of claim 1, wherein the recyclable products comprise at least one selected from the group consisting of a plastic bottle, a glass bottle, a plastic container, a glass container, a metal container, paper, an electronic product and a medical product.

14. A system for managing and tracking recyclable products, the system comprising:
a plurality of remote computers of recycling users;
a central server;
a network interface in communication with the central server and the plurality of remote computers over a network, the network interface being configured to receive a tracking information associated with one or more recyclable products;
a database in communication with the central server;
wherein the central server is configured to:
uniquely associate one or more recyclable products with unique identifiers and other product information stored in the database, wherein each recyclable product includes indicia that is both a unique scannable identifier and a visual indicator that the recyclable product is recyclable, and the visual indicator is arranged to encourage recycling;
receive tracking information associated with the one or more recyclable products, wherein the tracking information includes information scanned at one or more stages of the lifecycle of the one or more recyclable products;
periodically store and update the tracking information in the database;
associate the unique identifier with a recycling user having user account information stored in the database, wherein the user account information includes user information comprising a reward total and recycling data associated with the recycling user;
update the reward total based on a recycling activity of the recycling user; and
communicate the product information, tracking information, and account information to the recycling user via a first computer of the plurality of remote computers over the network interface.

15. The system of claim 14, wherein the indicia is a unique bar code combined with a graphical symbol indicating to the recycling user that the one or more recyclable products are recyclable.

16. The system of claim 15, further comprising an optical scanner configured scan the bar code and communicate tracking information to the database via the network.

17. The system of claim 15, wherein the indicia is an optically scannable unique identifier combined with a graphical symbol indicating to the recycling user that the one or more recyclable products are recyclable.

18. The system of claim 17, wherein the optically scannable identifier is scanned using at least one of an x-ray, an opti-scanner, a material resonance scanner, and a UV scanner.

19. The system of claim 15, wherein the indicia is an RFID combined with a graphical symbol indicating to the recycling user that the one or more recyclable products are recyclable.

20. The system of claim 15, wherein the unique bar code is sequential and predictable.

21. The system of claim 15, wherein the unique bar code is non-sequential and non-predictable.

22. The system of claim 15, wherein at least one of the product information, tracking information, and account information is communicated to the recycling user over a network via at least one selected from the group consisting of SMS, an email and a communication protocol.

23. The system of claim 15, further comprising a seventh computer code for verifying a status of one or more recyclable products using at least one selected from the group consisting of SMS, a hand-held scanner, and a camera phone.

24. The system of claim 15, further comprising a seventh computer code for allowing the recycling user to confirm that the one or more recycling products has been reprocessed.

25. The system of claim 15, further comprising a seventh computer code for allowing the recycling user to confirm that the one or more recycling products contains toxic materials.

26. The system of claim 14, wherein the recyclable products comprise at least one selected from the group consisting of a plastic bottle, a glass bottle, a plastic container, a glass container, a metal container, paper, an electronic product and a medical product.
